(19) United States
(12) Patent Application Publication
(10) Pub. No.: US 2012/0302215 A1
(43) Pub. Date: Nov. 29, 2012

(54) Method and Call Controller for Screening Calls Using a Voicemail System on Command of the Called Party

(75) Inventor: Oliver Speks, Eschweiler (DE)

(73) Assignee: TELEFONAKTIEBOLAGET L M ERICSSON (PUBL), Stockholm (SE)

(21) Appl. No.: 13/503,203

(22) PCT Filed: Oct. 23, 2009
(86) PCT No.: PCT/EP2009/063988

§ 371 Date: May 18, 2012

(51) Int. Cl. H04W 4/00

(52) U.S. Cl. 455/413

(57) ABSTRACT

A method is described for screening calls using a voice-mail system in a communication network (106). A call is initiated between a calling party (102) and a called party (104). The calling party is connected to a voicemail system (108), when the called party (104) answers the call or if the called party does not answer when a timer expires. If the called party answers the call a conference call is established (210) so that the call can be screened from the start of the message being left, and also intercepted if desired.

### TECHNICAL FIELD

The present invention relates to a method for handling of calls in a communication network. A call controller and a program embodying the invention are also described.

### BACKGROUND

There can be situations when a telephone user does not want to answer an incoming call unconditionally. Common criteria for deciding if a call should be answered at a given moment can be, among others, the identity of the caller or the subject and urgency of the call. Sometimes the identity of the caller can not be deducted from the phone number or the call is made at a moment which is not suitable for the called party to answer without knowing from whom the call is coming or what the purpose of the call is.

A number of solutions exist today which may support a party receiving a call and not wanting to answer the incoming call unconditionally. One of these solutions enables a called party to choose whether or not to answer a call based on transferred calling party identification. This method uses the Calling Party Number Presentation service (CPN). Nevertheless the transfer of the calling party number is not always supported by the network which serves the calling party or by a possibly used transit network. Furthermore the number may not be known to the called party. It may identify the phone number associated to the phone the caller is using, but not necessarily identify the person. Also the subject or purpose of the call is not possible to be identified by simply identifying the caller.

In the case of a fixed network there is the following possibility: if the calling party is directed to a voicemail because the call is not answered and leaves a message on an answering machine, the called party may listen in while the recording is made. This allows the called party to decide whether or not to accept the call and do so while the caller is still connected. This solution has the drawback that it is only possible for subscribers using an answering machine that is co-located with the telephone set. Furthermore the called party has to be physically present where the answering machine and the telephone set are located. Furthermore, it cannot be used together with conditional or unconditional call forwarding to other phones.

Such a procedure where the called party has the possibility to check who is calling and possibly the purpose of the call is known as call screening. Call screening allows a real-time decision of the called party whether or not to accept an incoming call. Call screening is considered to be a service that can be provisioned both to fixed and mobile subscribers.

There can be some criticism against call screening services as they may result in calls being rejected before being answered. In case the caller realizes that the call is rejected he or she is likely to be offended. Therefore screening methods whose usage is not made obvious to the calling party are preferable over methods that are made obvious.

There are other solutions which are offered to users of mobile networks and which allow screening of incoming calls without being obvious to the calling party. In one of these solutions, as described in US Patent application 2006/0029189, a call from a calling party is routed to a voice mail server and the calling party gets the opportunity to leave a message. After a configurable amount of time, the message that has been recorded so far is sent to the called party through an Internet Protocol Multimedia Subsystem (IMS) message service delivery or Push-to-talk over cellular (PoC), while the recording continues. The called party is then prompted to accept or reject the call. Upon acceptance, the call is routed from the voice mail server to the called party. Using this method the called party always listens to the initial, possibly truncated, part of the recorded message. This has the drawback that the called party cannot hear the complete message that the caller leaves, but only the beginning. This may be sufficient to identify the caller, but may not always be sufficient to determine other screening factors, such as the subject matter or urgency of the call.

In another solution, as described in US Patent application 2004/0258220, the call is first routed to the phone of the called party. If the call is not answered or if the called party is busy, the call is routed to a service node, which further routes the call to a voice mail service node. The caller hears an announcement, a tone and then the recording starts. In parallel to the call leg from the service node to the voice mail system, an additional call leg from the service node is set up towards the called party. Recording at the voice mail service starts independent of the point in time that the called party answers. This solution allows the called party to “drop in” the call without being noticed, while the recording is already going on. This leads to the following problems that grow with the time it takes for the calling party to answer the call. The initial part of the recording is most probably lost as the called party “drops in” the call after the recording has started. Usually the initial part is where a caller mentions his/her name and the purpose of the call. Also the likelihood for the calling party to have ended the recording and have disconnected the call increases with the time it takes for the called party to decide if the call should be answered and to finally answer the call.

### SUMMARY

It is an object of the present invention to obviate the above disadvantages and provide an advantageous method for handling of calls in a communication network, allowing an advantageous call screening.

According to the invention, the method described in claim 1 is performed. Furthermore, the invention is embodied in a call controller and a program as described in the further independent claims. Embodiments of the invention are described in the dependent claims.

A method for handling of calls in a communication network is proposed. A call between a calling party and a called party is initiated. In response to the call being initiated, the calling party is connected to a voicemail system. The access of the calling party to the voicemail system is controlled based on an answer of the call by the called party.

Furthermore, the invention can be embodied in a call controller for the establishment of a call between a calling party and a called party in a communication network. The call controller comprises a connecting entity which is adapted to control the call establishment between the calling party and a voicemail system. The call controller further comprises an access control entity which is adapted to control an access of the calling party to the voicemail system when the called party answers the call.

The method can also be embodied in a program which is, for example, stored on a data carrier or loadable into a processing system of a control device, e.g. as a sequence of signals.

The proposed method and call controller provide handling and establishment of calls in a communication network, allowing an advantageous call screening.

The foregoing and other objects, features and advantages of the present invention will become more apparent in the following detailed description of preferred embodiments as illustrated in the accompanying drawings.

### BRIEF DESCRIPTION OF THE DRAWINGS

FIG. 1 shows an embodiment of a mobile network

FIG. 2 shows a flow diagram of an embodiment of the proposed method

FIG. 3 shows a signaling diagram of an embodiment of the invention in a circuit switched network

FIG. 4 shows a signaling diagram of an embodiment of the invention in a packet switched network

FIG. 5 shows a call controller which is adapted to perform the proposed method

### DETAILED DESCRIPTION

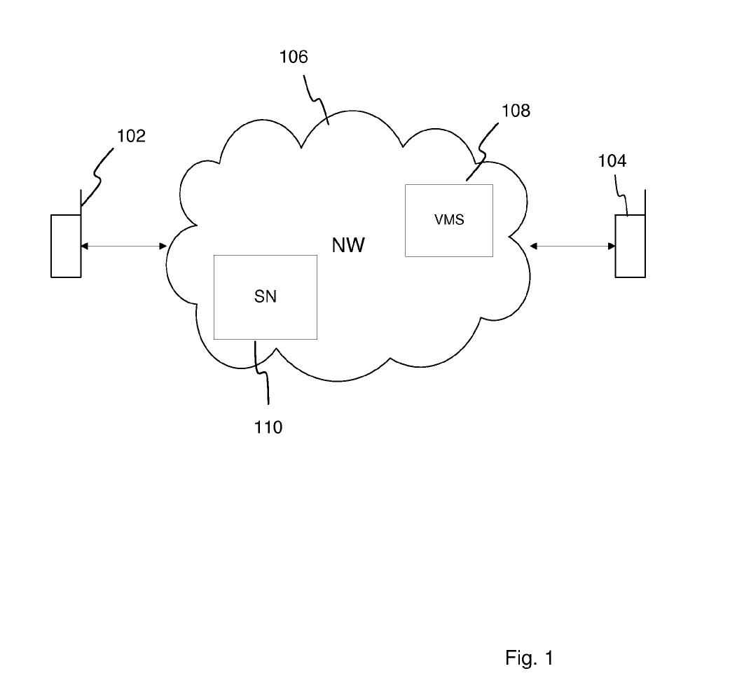

FIG. 1 shows an embodiment of a mobile network. Two mobile devices 102 and 104 are connected over a mobile network 106. The mobile devices can be also referred to as a calling and a called party and be used by mobile service subscribers e.g. a calling and a called subscriber. The mobile network 106 shown in FIG. 1 is a general representation of networks which can connect the two parties and comprise, for example, the home network of the called party.

Within the mobile network 106 there is a service node (SN) 110 which is responsible for handling calls between the two mobile devices 102, 104. The SN can also be called a call controlling node or a call controller and can also be responsible for invoking a call screening service. Also within the mobile network 106 there can be a voicemail system (VMS) 108 serving e.g. the called subscriber. The VMS is usually located in the home network of a subscriber. The SN can also handle connections towards the VMS.

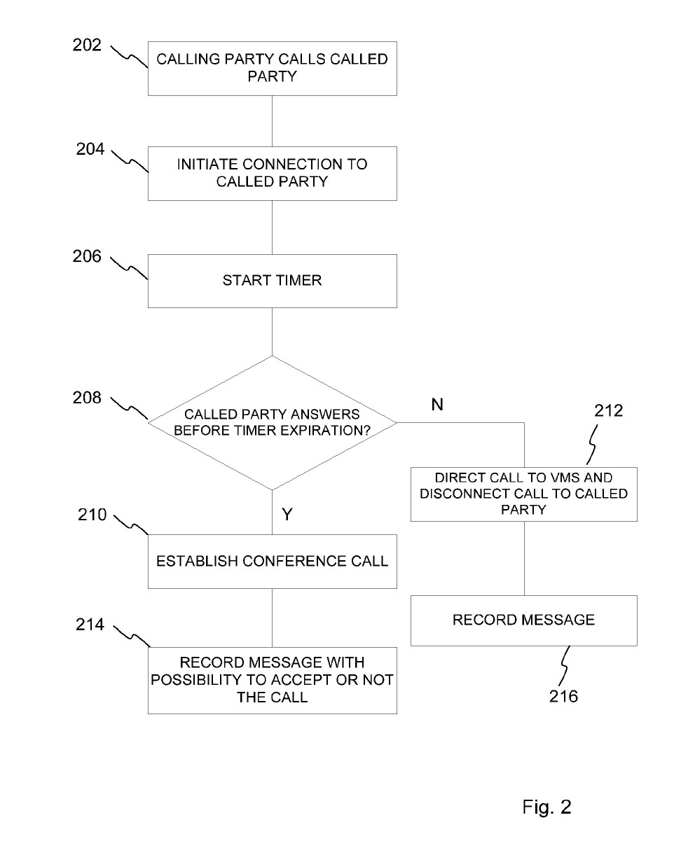

FIG. 2 shows a flow diagram of an embodiment of the proposed method. It is assumed that a calling party calls a called party in step 202. The two parties are connected over a mobile network. A voicemail system is provisioned for the called party. In step 204, a service node which can be, for example, a gateway mobile switching center (GMSC) in the home network of the called party, initiates a connection towards the called party. The following steps, as they will be described below, comprise the proposed call screening method and therefore a party executing these steps is considered to actually make use of a call screening service as implemented by the proposed method.

In step 206, a timer is started e.g. by the service node. Purpose of the timer is to serve as a mechanism for determining the events occurring upon an answer of the call from the called party. In this sense, a check is performed in step 208 as to whether the called party answers the call before the timer expires. If the call is not answered before the timer expires then, in step 212, the service node directs the call to the voicemail system of the called party and releases the call connection towards the called party. A message can be then recorded in step 216.

If the call is answered by the called party before the timer expires then, in step 210, a conference call is established. The called party may answer the call by e.g. pressing one or more buttons on a communication device which may consequently result in the sending of a signal e.g. a service invocation signal, from the communication device to the service node. Answering the call before the timer expires, the called party may actually decide to invoke the call screening service and therefore the signal sent to the service node can be a service invocation signal.

The conference call is enabling a three party connection between the calling party, the called party and the voicemail system. The conference call may be configured so that it only allows a one-way speech connection towards the called party. This prohibits the called party to communicate towards the calling party. In step 214 a message by the calling party is recorded in the voicemail system. Since the conference call is still established the called party can listen in real time to the recording made in the voicemail system and either accept or not accept the call, as will be explained below. From that point onwards there are a number of different scenarios which may occur, depending on the reaction of the called party.

In one of these scenarios, if the called party decides to accept the call, then the service node releases the connection between the calling party and the VMS and can indicate to the VMS that it may discard the recording made up to that point. The conference call is also released. The connection between the calling and the called party remains. In this case the remaining connection is converted to a two-way speech communication between the calling and the called party. This can be achieved, for example, if the service node sets up a normal two-way speech connection between the calling and the called party. The acceptance of the call by the called party can be recorded e.g. as an event in the charge data record of the called subscriber and thus the called party could be charged for accepting the call or for the remaining duration of the call.

Similarly to answering the call, the called party may accept the call by e.g. pressing one or more buttons on a communication device. This may consequently result in the sending of a signal e.g. a call acceptance signal, from the communication device to the service node.

In another scenario, the called party may decide not to accept the call. In this case the service node releases the conference call. The calling party continues to be connected to the VMS.

In an embodiment, when the called party receives a call and answers it, a delay can be introduced before the called party can talk to the calling party. The delay can be e.g. controlled by a timer and during this delay the calling party would still hear the ringing tone. The called party may hear an indication tone and/or a message that informs about the option to invoke the call screening service.

The called party may choose to react to this message e.g. by pressing a button on the communication device before the end of the delay, thus indicating that it wants to invoke the call screening service. In this case the ringing tone towards the calling party is stopped and then the call screening service as described above is invoked. If the called party chooses not to react to the message when the delay is over, the ringing tone towards the calling party is stopped and a two-way speech connection is established between the calling and the called party

As mentioned above the SN can be the GMSC in the home network of the called party. In a wire line network the SN can be the local telephony switching center serving the called party. Accordingly the proposed method can also be used in a wire line network where one or both parties correspond to fixed terminal devices.

The description of the flow diagram of FIG. 2 provided an overview of the proposed method for handling a call in order to enable call screening at the side of the called party. Further in the text a more detailed description of the call handling will be made.

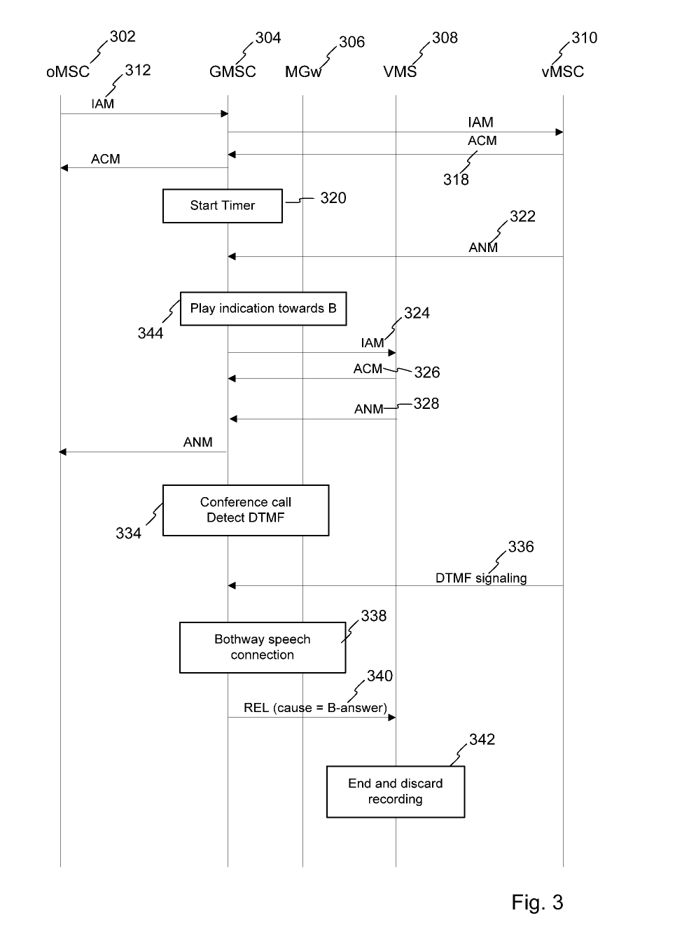

FIG. 3 shows a signaling diagram of an embodiment of the invention in a circuit switched network, e.g. a 3GPP or GSM network where the circuit switched signaling and payload can also be transported over packet switched bearers. It is assumed that a call is made from a calling party towards a called party. The calling party is served by a Mobile Switching Center (MSC). Since the call originates from the calling party the MSC serving the calling party can be considered as the originating MSC (oMSC) 302. An Initial Address Message (IAM) 312 is sent from the oMSC 302 to the GMSC 304. The GMSC 304 is the MSC that determines which visited MSC (vMSC) 310 serves the party who is being called. The vMSC 310 can also be called a terminating MSC. The GMSC 304 can be considered the service node as mentioned before. The IAM 312 that arrives at the GMSC 304 may trigger a check as to whether a call-screening service is provisioned for the called party. Also a check can be performed as to whether the execution of the call-screening service may interfere with other supplementary services like, for example, a call forwarding service. After locating the called party (not shown in FIG. 3), the GMSC 304 routes the call to the vMSC 310 serving the called party in the visited network by sending further to it the IAM 312 message. The called party does not need to be in a visited network but can also be in its home network. An Address Complete Message (ACM) 318 is transferred from the terminating MSC through the GMSC 304 to the oMSC 302 indicating that the call has reached the destination e.g. the called party. If a call-screening service is provisioned for the called party, at reception of ACM 318 the GMSC 304 starts a timer. As mentioned before, the timer can serve as a controlling mechanism for the events occurring upon an answer of the call from the called party. If the timer expires without the called party answering the call or with the called party being busy or not reachable, the GMSC 304 stops the connection towards the called party and sets up a new connection towards the VMS 308 sending an IAM 324 to it.

If the called party answers the call before the timer expires, the GMSC 304 sets up an additional connection towards the VMS 308 sending an IAM 324 as mentioned above. A reception of an ACM 326 message from the VMS 308 confirms successful establishment of the connection. The GMSC 304 is notified for an answer by the called party by receiving an Answer Message (ANM) 328 from the visited MSC 310. The GMSC 304 orders the media gateway (MGw) 306 to move the terminations belonging to the calling party, the called party and the voicemail system to a conference call context 334. The GMSC 304 configures the conference to allow only a one-way speech connection towards the called party. Also the GMSC 304 requests from the MGW 306 to detect a Dual-Tone Multi-Frequency (DTMF) signal 334 on the connection from the called party. When the GMSC 304 is informed by the MGw 306 about reception of a DTMF signal 336, this is interpreted as a sign of call acceptance by the called party. The DTMF signal 336 can be generated e.g. by pressing a digit button on a mobile device of the called party. When such a DTMF signal 336 is received at the GMSC 304 it is assumed that the called party has accepted the call. Then the GMSC 304 releases the connection towards the VMS 308 and orders the MGw 306 to connect the calling party and the called party enabling a two-way speech communication between the calling and the called party. In this case the connection allows a two-way speech communication between the parties. A release message (REL) 340 sent from the GMSC 304 to the VMS 308 can contain a specific cause code indicating that the called party has accepted the call. The REL message 340 with that cause code can trigger the VMS 308 to end the message recording and discard the recorded message 342.

Alternatively if the GMSC 304 receives a REL 340 from the called party without prior reception of a DTMF signal 336 notification from the MGw 306, the GMSC 304 can release the connection towards the called party. The connection between calling party and VMS 308 can remain. This may happen if the called party decides not to accept the call.

In an embodiment, upon reception of the ANM 322 from the called party, the GMSC 304 may order the MGw 306 to play an indication tone towards the called party 344 in order to make the party aware that a call screening service is activated and that the mechanism described above is performed.

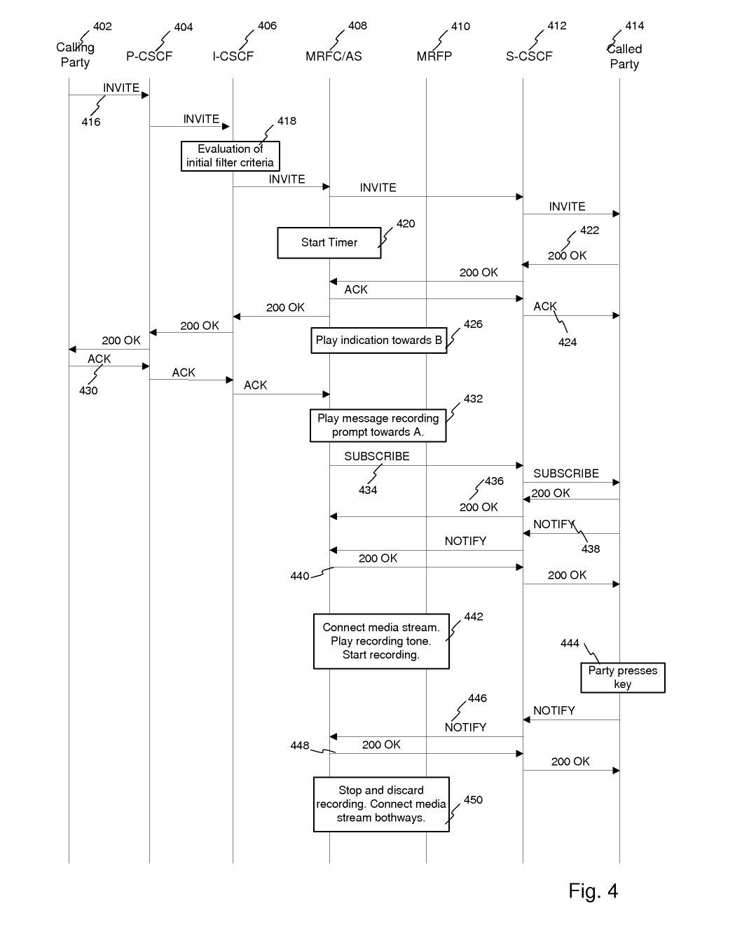

FIG. 4 shows a signaling diagram of an embodiment of the invention in a packet switched network. In this embodiment, the voice mail recording functionality and the functionality of the service node controlling the call screening service can be co-located in the same physical node, e.g. the Multimedia Resource Function Controller (MRFC). Alternatively, the voice mail recording functionality can be provided by a separate node.

A calling party 402 sends an INVITE message 416 to the Interrogating Call Session Control Function (I-CSCF) 406. The INVITE message 416 is used to establish a media session between parties, in our case a call between the calling 402 and the called 414 party. This message is received by the I-CSCF 406 over the proxy-CSCF (P-CSCF) 404 which is a Session Initiation Protocol (SIP) proxy that is the first point of contact for the calling party 402. At this point the I-CSCF 406 may evaluate some initial filter criteria 418, e.g. it may check if a call-screening service is provisioned for the called party 414. If such a service is provisioned, the I-CSCF 406 passes the INVITE message 416 to the MRFC/Application Server (AS) 408. The MRFC/AS 408 forwards the INVITE message 416, through the S-CSCF 412, to the called party 414 and thus establishes a connection to the called party 414. Also the MRFC/AS 408 starts a timer 420 whose expiration can serve for determining the events occurring upon an answer of the call from the called party.

The called party answers the call by sending a 200 OK message 422 towards the calling party 402. Since the timer determines the events occurring upon an answer of the call from the called party 414, as soon as the called party 414 answers, the MRFC/AS 408 stops the timer and orders the MRFP 410 to play an indication tone (or announcement) 426 towards the called party 414 notifying it of the provision of the call screening service. At reception of an ACK message 430 from the calling party 402 confirming the reception of the 200 OK message 422, the MRFC/AS 408 orders the MRFP 410 to play an announcement 432 prompting the caller to leave a message after a tone.

The MRFC/AS 408 sends a SUBSCRIBE message 434 to the called party 414 in order to receive a notification about a keypad stimulus indicating a call acceptance from the called party 414. The confirmation from the called party 414 consists of reception at the MRFC/AS 408 of a 200 OK message 436 and of a NOTIFY message 438 in reply. The MRFC/AS 408 confirms the reception of the NOTIFY message 438 with one 200 OK message 440.

Once the connections towards the calling party 402 and the called party 414 are established and the subscription for the notification of a key press stimulus is successful, the MRFC/AS 408 orders the MRFP 410 to connect the media stream in forward direction from the calling party 402 to the called party 414. The media stream can be the voice message from the calling party 402. The MRFC/AS 408 also orders the MRFP 410 to play a recording tone 442 towards the calling party 402 in order to prompt the calling party 402 to leave a message to be recorded. In this setup the called party 414 can listen in while the recording is being made and to the recording itself.

If the called party 414 decides to accept the call then it can indicate the acceptance by pressing 444 a key or button on the keypad. A NOTIFY message 446 will then be sent to the MRFC/AS 408. The MRFC/AS 408 confirms the reception of the NOTIFY message 446 with one 200 OK message 448. The NOTIFY message 446 serves as a trigger for the MRFC/AS 408 to order the MRFP 410 to stop and optionally discard the recording made up to this point and to establish a both way media stream connection 450 between the calling 402 and the called 414 party.

Alternatively if the called party 414 disconnects from the call, then only the connection towards the called party 414 is released by the MRFC/AS 408. The recording continues and no notification is sent to the calling party 402.

The signaling diagrams of FIGS. 3 and 4 can be considered simplified as they only show the messages exchanged which are relevant for the description of the corresponding embodiment of the invention.

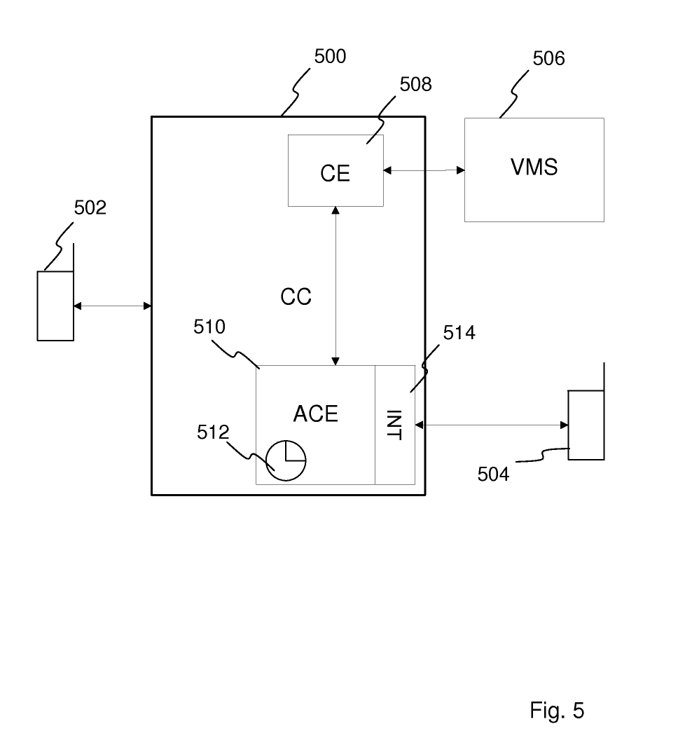

The invention can be embodied in a call controller for the establishment of a call between a calling party 502 and a called party 504. The call controller can be adapted to perform any embodiments of the proposed method as described above. An embodiment of such a call controller is shown in FIG. 5. The call controller (CC) 500 comprises a connecting entity (CE) 508. The CE 508 can control the establishment of connections between the calling party 502 and a voicemail system (VMS) 506. The VMS 506 can be, for example, in the home network of the called party 504. The CE 508 can also control the establishment of connections between the called party 504 and the voicemail system 506. The CC 500 further comprises an access control entity (ACE) 510 which can control the access of the called party 504 to the VMS 506.

When a call is made from the calling party 502, the CC 500 establishes a connection towards the called party 504. The connection towards the called party 504 can be established over the CE 508. The ACE 510 comprises a timer 512. Once the connection to the called party 504 is established, the ACE 510 starts the timer 512. The timer 512 may determine the triggering of certain events occurring upon an answer of the call by the called party 504. In this context, if the call is not answered before the timer expires, indicating e.g. that the called party 504 is unavailable or does not react to the call, the ACE can release the call connection towards the called party 504. Further the ACE can order the CE 508 to connect the calling party 502 to the VMS 506.

If the called party 504 answers the call before the timer 512 expires then the ACE 510 orders the CE 508 to connect the calling party 502 to the VMS 506. At the same time the ACE 510 orders the CE 508 to establish a conference call which enables a three party connection between the calling party 502, the called party 504 and the VMS 506. The CE 508 can configure the conference call to allow a one-way speech connection from the calling party 502 to the called party 504 and from the VMS 506 to the called party 504.

The ACE 510 also comprises an interface 514 for receiving signals from the called party. When the called party 504 answers the call using a communication device e.g. a mobile phone, a signal, sent by the mobile phone to confirm the answer, is received by the interface 514.

If the called party 504 decides to accept the call, then a signal confirming the call acceptance e.g. a call acceptance signal, is sent from the communication device of the called party 504 to the interface 514. In this case the ACE 510 may order the CE 508 to release the connection between the calling party 502 and the VMS 506. Furthermore the ACE 510 may order the CE 508 to indicate to the VMS 506 that it may discard the recording made up to that point.

If the called party 504 decides not to accept the call, then a call cancelling signal can be sent to the interface 514. The ACE 510, upon reception of this signal may order the CC 508 to release the connection between the calling party 502 and the called party 504 and to also interrupt the conference call.

The CE and the ACE can be implemented e.g. in a processor of a call control node such as a GMSC or an MRFC.

In an embodiment, the CC 500 may also comprise the VMS 506. In this case nothing changes in the description of the different embodiments made above. The only difference is a structural modification of the CC 500.

The above embodiments admirably achieve the objects of the invention.

However, it will be appreciated that departures can be made by those skilled in the art without departing from the scope of the invention which is limited only by the claims.

1.-12. (canceled)

13. A method for handling calls in a communication network in which a calling party initiates a call to a called party, the method being implemented in a service node, and comprising:
providing the calling party with access to a voicemail system in response to the called party providing an answer to the call, wherein the answer comprises a service invocation signal; and
establishing, upon detection of the service invocation signal, a conference call between the calling party, the called party, and the voicemail system.

14. The method of claim 13 further comprising establishing a speech connection between the calling party and the called party upon detection of a call acceptance signal from the called party.

15. The method of claim 14 further comprising discarding a message recorded in the voicemail system responsive to detection of the call acceptance signal.

16. The method of claim 13 wherein establishing a conference call comprises providing a one-way speech connection from the calling party to the called party.

17. The method of claim 13 further comprising:
determining whether a telephony service provisioned for the called party will interfere with establishment of the conference call;
wherein the step of establishing a conference call is only performed if the determining indicates that the telephony service will not interfere.

18. The method of claim 13 further comprising:
initiating a timer responsive to the calling party initiating the call to the called party;
wherein the step of providing the calling party with access to a voicemail system is triggered by expiration of the timer.

19. A call controller operative to establish a call between a calling party and a called party in a communication network, the call controller comprising:
a connecting entity circuit configured to control the establishment of a connection between the calling party and a voicemail system; and
an access control entity circuit configured to:
provide the calling party with access to the voicemail system in response to the called party providing an answer signal for the call;
provide the called party with access to the voicemail system; and
trigger the connecting entity circuit to connect the called party to the voicemail system upon reception of the answer signal from the called party.

20. The call controller of claim 19:
wherein the access control entity circuit comprises a timer;
wherein the access control entity circuit is further configured to trigger the connecting entity circuit to connect calling party to the voicemail system upon expiration of the timer.

21. The call controller of claim 19:
wherein the access control entity circuit comprises an interface for receiving the answer signal from the called party;
wherein reception of the answer signal also triggers providing the calling party with access to the voicemail system.

22. The call controller of claim 19 wherein the call controller further comprises the voicemail system.

23. A computer program product stored in a non-transitory computer-readable medium, the computer program product comprising program instructions for handling calls in a communication network, the computer program product comprising computer program code which, when run on a call controller, configures the call controller to:
provide a calling party with access to a voicemail system in response to a called party providing an answer to a call from the calling party, wherein the answer comprises a service invocation signal; and
establish, upon detection of the service invocation signal, a conference call between the calling party, the called party, and the voicemail system.
